(19) United States
(12) Patent Application Publication
(10) Pub. No.: US 2023/0379772 A1
(43) Pub. Date: Nov. 23, 2023

(54) A METHOD OF OPERATING USER EQUIPMENT IN A TELECOMMUNICATIONS NETWORK

(71) Applicant: BRITISH TELECOMMUNICATIONS PUBLIC LIMITED COMPANY, London (GB)

(72) Inventors: Jonathan HART, London (GB); David TOWNEND, London (GB); Richard MACKENZIE, London (GB)

(21) Appl. No.: 18/248,016

(22) PCT Filed: Oct. 1, 2021
(86) PCT No.: PCT/EP2021/077087

§ 371 Date: Apr. 5, 2023

(30) Foreign Application Priority Data
Oct. 7, 2020 (GB) 2015882.0

(51) Int. Cl. H04W 36/00; H04W 48/20; H04W 36/08; H04W 36/30

(52) U.S. Cl. CPC H04W 36/0079; H04W 48/20; H04W 36/08; H04W 36/305

(57) ABSTRACT

A method of operating User Equipment (110), UE, the UE being configured to connect to a wireless wide-area cellular telecommunications network (100), said telecommunications network comprising a plurality of radio access points (120, 130), and the method comprising the steps of: identifying, from the plurality of radio access points, a default radio access point for the UE; identifying, from the plurality of radio access points, an alternative default radio access point for the UE, wherein said identifying is performed based on the alternative default radio access point and the default radio access point having been simultaneously available to the UE for wireless connection and wherein the UE is instructed to connect to the default radio access point in preference to the alternative default radio access point; connecting the UE to the default radio access point (210); in response to the UE detecting a subsequent loss of connection with the default radio access point, the UE directly initiating only a connection with the identified alternative default radio access point (260).

### FIELD OF INVENTION

The present invention relates to a method of operating user equipment in a telecommunications network, and in particular for network access via small cells.

### BACKGROUND

Cellular telecommunications networks incorporate radio access points, such as so-called small cells, which are characterised as radio access points for cellular telecommunications networks having relatively low-powered transmitters (relative in comparison to macrocells). Examples of small cells include femtocells, picocells and microcells, which are each in turn characterised by different (and respectively decreasing) radio transmission power.

As with other forms of radio access points for cellular telecommunications networks, small cells are connected to a core network of the cellular telecommunications network by means of a backhaul link. Accordingly, User Equipment (UE) is able to access the cellular telecommunications network by connecting to a small cell.

In comparison to a macrocell, the backhaul connection of a small cell may be less resilient, and therefore more prone to failure. If the backhaul link for a given small cell fails, the small cell will no longer be able to communicate with the core network; in response, the usual behaviour of a small cell is to cease transmission by deactivating its component transmitter.

Consequently, UEs will lose connection to that small cell and will therefore suffer a loss of service. In response, the UE will initiate a cell reselection process in order to find available alternative radio access points, identify a most suitable radio access point and then attempt attachment to that identified radio access point. However, conventional cell reselection processes involve significant processing by the UE and signalling overhead between the UE and available radio access points (which may be numerous) to re-establish service.

It is therefore an aim of the present invention at least to alleviate some of the aforementioned problems.

### STATEMENTS OF INVENTION

According to a first aspect of the present invention, there is provided: a method of operating User Equipment (UE), the UE being configured to connect to a wireless wide-area cellular telecommunications network, said telecommunications network comprising a plurality of radio access points, and the method comprising the steps of: identifying, from the plurality of radio access points, a default radio access point for the UE; identifying, from the plurality of radio access points, an alternative default radio access point for the UE, wherein said identifying is performed based on the alternative default radio access point and the default radio access point having been simultaneously available to the UE for wireless connection and wherein the UE is instructed to connect to the default radio access point in preference to the alternative default radio access point; connecting the UE to the default radio access point; in response to the UE detecting a subsequent loss of connection with the default radio access point, the UE directly initiating only a connection with the identified alternative default radio access point.

In this way, there is provided an override mechanism to existing preferential cell selection methods, which may establish, more quickly and in a more processing- and signalling-efficient manner, cell reselection by defaulting to the alternative default radio access which can be expected to be available when the default radio access point is not available. Preferably, said detecting a subsequent loss of connection includes the UE detaching from the default radio access point. Preferably, the default radio access point is characterised as the most-preferred radio access point for a given UE, such that when the default radio access point is available, the UE is obliged first to attempt a connection to the default radio access point before any other radio access point. Preferably, the alternative default radio access point is characterised as the second most-preferred radio access point for a given UE, such that when the default radio access point is unavailable, the UE is obliged to attempt a connection to the alternative default radio access point before any other radio access point, after the default radio access point, when it is available.

Optionally, the loss of the connection with the default radio access point is caused by cessation of transmission by the default radio access point, and optionally said cessation is caused by deactivation of a transmitter of the default radio access in response to a failure in a backhaul connection between the default radio access point and a core of the telecommunications network.

Optionally, the default radio access point and the alternative default radio access point are operated by the same operator. Preferably, identifying the default radio access point is performed upon performing an initialisation procedure of the UE (such as a setup procedure or a reboot). Preferably, only a single radio access point is identified as the default radio access point. Optionally, a plurality of radio access points are each identified as an alternative default radio access point.

Preferably, initiation of the connection to the alternative default radio access point is performed without the UE attempting attachment to a radio access point other than the alternative default radio access point. Preferably, as used herein, “initiating a connection” in relation to a radio access point may include any communication generated and/or transmitted by the UE for a radio access point so as to identify a radio access point and/or to establish a connection to a radio access point. In particular, “initiating a connection” may include the steps of searching, measurement, evaluation, and attachment in relation to radio access point selection. Preferably, the initiation of the connection to the alternative default radio access point is performed by the UE bypassing radio access point searching, measurements and/or evaluation process/es.

Preferably, directly initiating only a connection with the alternative default radio access point is performed despite at least another radio access point of the being available to the UE for wireless connection. Optionally, the at least another radio access point forms part of the telecommunications network. Optionally, the default radio access point and the alternative default radio access point are operated by an operator that differs from an operator of the at least another radio access point.

Preferably, the identity/identities of the default and/or the alternative default radio access point/s is/are stored within memory of the UE (or, at least, within a memory component controlled by the UE), and more preferably within a Subscriber Identity Module (SIM).

Preferably, the default radio access point is a small cell. Due to the typically lower availability and reliability of small cells compared to other types of radio access points, the resulting benefit that may be provided may be realised all the more often when applied specifically to small cells. Preferably, the alternative default radio access point is a small cell.

Preferably, identifying the default radio access point comprises identifying a radio access point that is available to the UE at a pre-defined geographic location. Preferably, said pre-defined geographic location is predefined by a user of the UE. Optionally, wherein identifying the default radio access point comprises identifying a radio access point that is available at a most-frequently visited location by a UE.

Preferably, identifying the default radio access point and/or the alternative default radio access point is performed in dependence upon a total duration of connections with the UE, and more preferably upon a predefined (e.g. threshold) total duration of connections. Optionally, the radio access point to which the UE has had the longest total connection duration is identified as the default radio access point.

Preferably, identifying the default radio access point and/or the alternative default radio access point is performed in dependence upon a total number of instances of connections with the UE. Optionally, the radio access point to which the UE has had the most total number of instances of connection is identified as the default radio access point. Optionally, the total duration of connections and/or total number of instances of connections are measured for all time for the UE.

Preferably, identifying the default radio access point and/or the alternative default radio access point is performed in dependence on a level of network performance. Preferably, network performance includes signal strength; speed; latency; bandwidth; and availability. Preferably, wherein said network performance is as measured by the UE.

Preferably, the level of network performance comprises an average of a plurality of measurements for network performance over a period of time.

Preferably, identifying the default radio access point and/or the alternative default radio access point comprises identifying a radio access point providing a pre-defined network function. Preferably, said network function is available to include: operation at a given radio-frequency band; and/or network a service, such as VoWiFi.

Preferably, identifying the default radio access point and/or the alternative default radio access point comprises identifying a radio access point having a network identifier that is associated with a telecommunications network that the UE is available to access. Preferably, the network identifier is a PLMN ID. Preferably, the UE is a subscriber of the network or has roaming access rights to the network.

Preferably, identifying the alternative default radio access point is only performed after the default radio access point has been identified. Preferably, identification of the default radio access point causes the UE to perform identification of the alternative default radio access point.

Preferably, the method further comprises the step of, in response to identifying a failure directly to initiate a connection with the alternative default radio access point, the UE performing a radio access point search and selection process for a radio access point other than the default radio access point and the alternative default radio access point. Preferably, the method further comprises the steps of: after initiating the connection with the alternative default radio access point, determining an availability of the default radio access point; and subsequently initiating a connection to the default radio access point if the default radio access point is determined to be available.

According to another aspect of the invention, there is provided a wireless wide-area cellular telecommunications network comprising: a plurality of radio access points; a UE for connecting to the telecommunications network via the plurality of radio access points, wherein said UE is configured to perform a method as described above.

According to yet another aspect of the invention, there is provided a computer-readable carrier medium comprising instructions which, when executed by a computer, cause the computer to carry out a method as described above.

The invention includes any novel aspects described and/or illustrated herein. The invention also extends to methods and/or apparatus substantially as herein described and/or as illustrated with reference to the accompanying drawings. The invention is also provided as a computer program and/or a computer program product for carrying out any of the methods described herein and/or for embodying any of the apparatus features described herein, and a computer-readable medium storing thereon a program for carrying out any of the methods and/or for embodying any of the apparatus features described herein. Features described as being implemented in hardware may alternatively be implemented in software, and vice versa.

The invention also provides a method of transmitting a signal, and a computer product having an operating system that supports a computer program for performing any of the methods described herein and/or for embodying any of the apparatus features described herein.

Any apparatus feature may also be provided as a corresponding step of a method, and vice versa. As used herein, means plus function features may alternatively be expressed in terms of their corresponding structure, for example as a suitably-programmed processor.

Any feature in one aspect of the invention may be applied, in any appropriate combination, to other aspects of the invention. Any, some and/or all features in one aspect can be applied to any, some and/or all features in any other aspect, in any appropriate combination. Particular combinations of the various features described and defined in any aspects of the invention can be implemented and/or supplied and/or used independently.

As used throughout, the word ‘or’ can be interpreted in the exclusive and/or inclusive sense, unless otherwise specified.

The invention extends to a method and a telecommunications network as described herein and/or substantially as illustrated with reference to the accompanying drawings. The present invention is now described, purely by way of example, with reference to the accompanying diagrammatic drawings, in which:

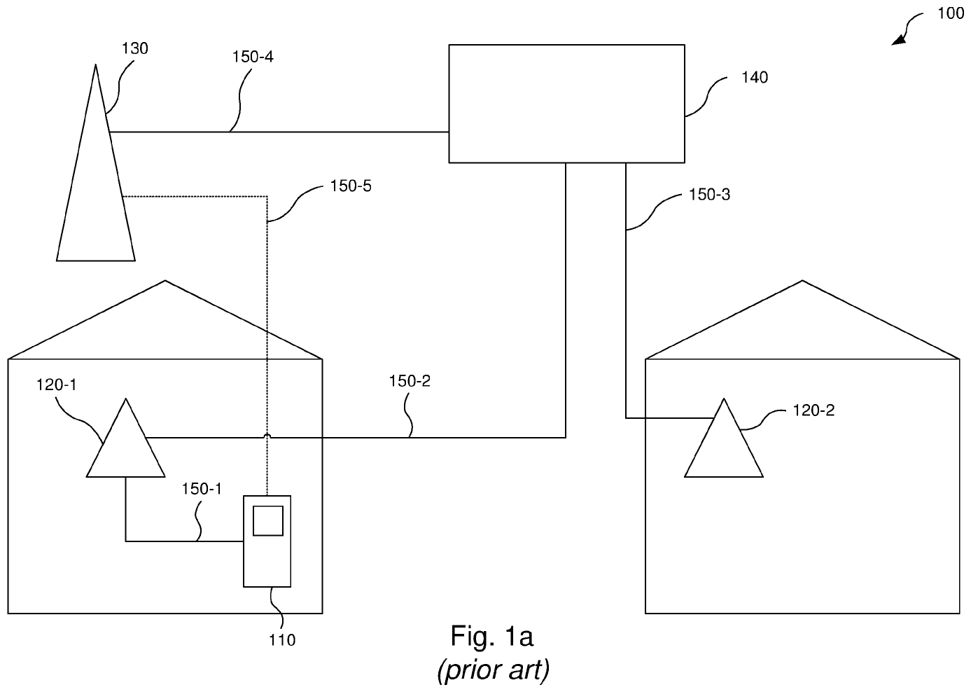

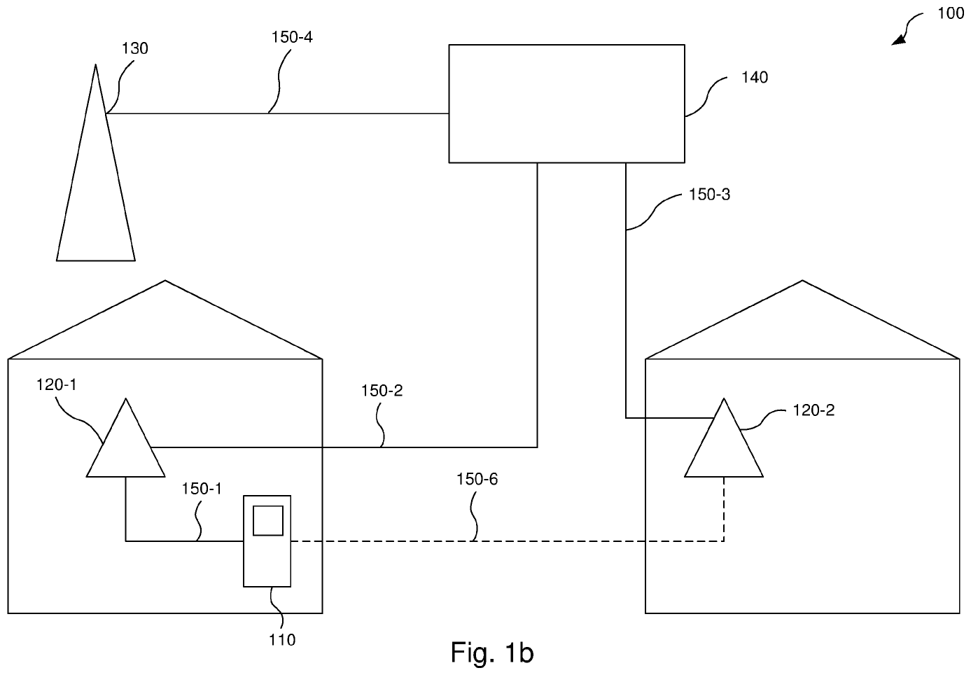

FIG. 1 show an exemplary cellular telecommunications network;

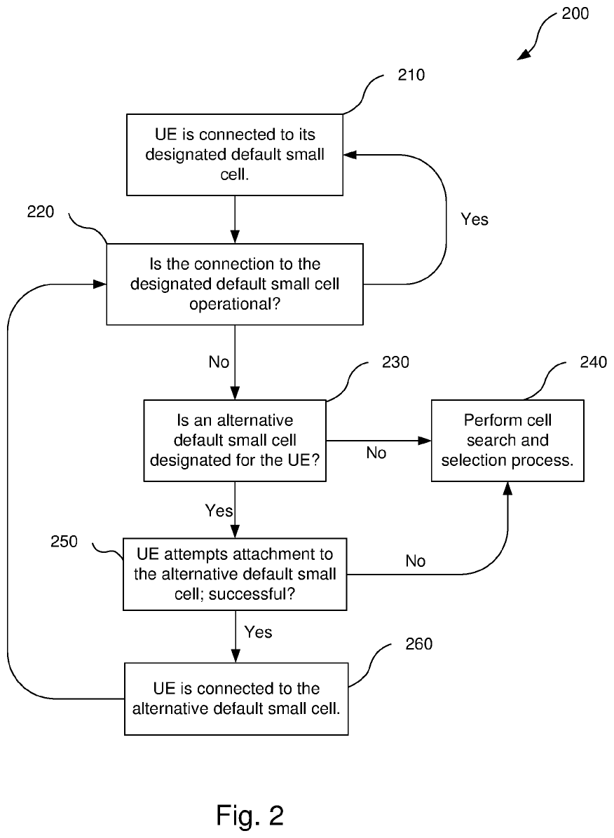

FIG. 2 shows a process for connecting to the cellular telecommunications network in the event of a failure of a small cell of the telecommunications network;

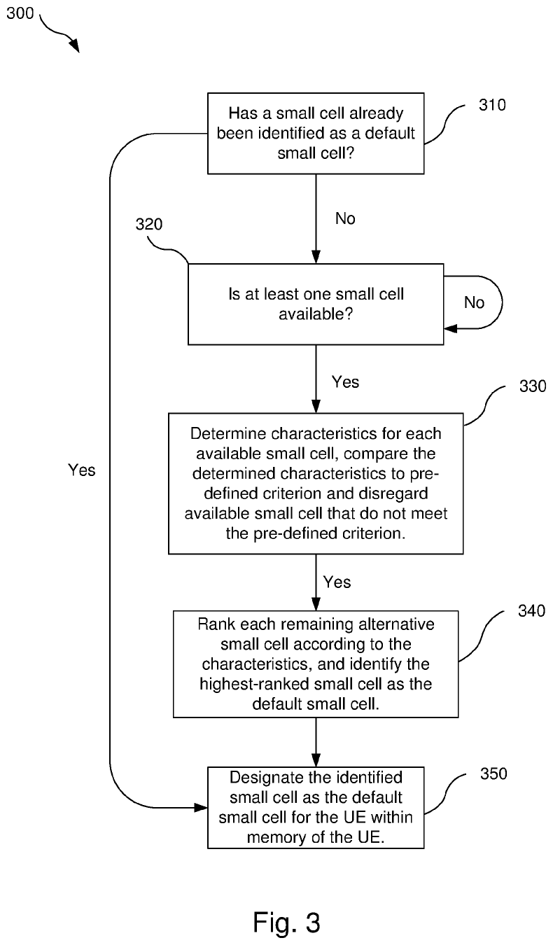

FIG. 3 shows a process for identifying a default small cell for a UE; and

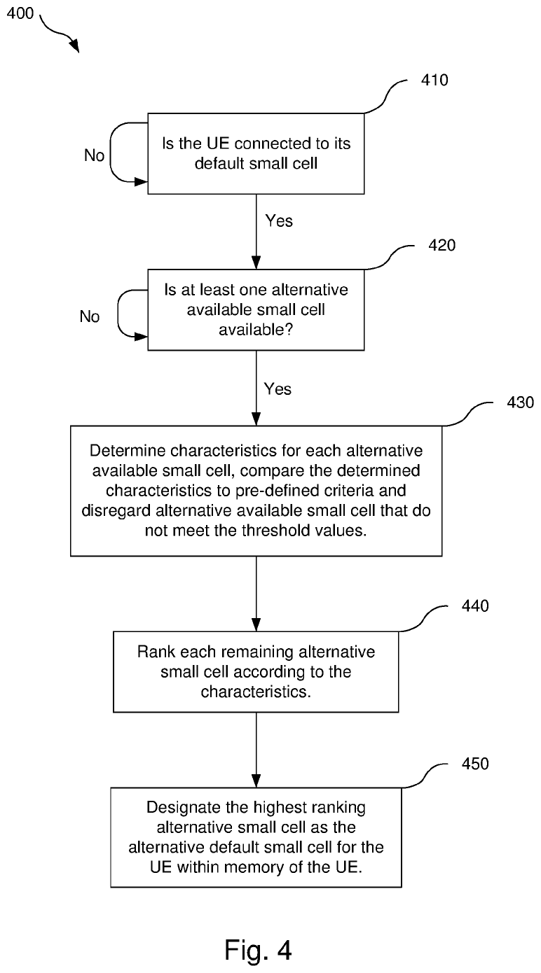

FIG. 4 shows a process for identifying an alternative default small cell for the UE.

### SPECIFIC DESCRIPTION

FIG. 1 are schematic diagrams of a cellular telecommunications network 100 comprising: a User Equipment (UE) 110; a plurality of radio access points in the form of a first small cell 120-1, a second small cell 120-2, and a macrocell 130; and a core network 140.

The first small cell 120-1, the second small cell 120-2 and the macrocell 130 form part of a Radio Access Network (RAN) of the telecommunications network 100.

In FIG. 1, the UE 110 is located in an area where it is capable of connecting to any of the first small cell 120-1, the second small cell 120-2 and the macrocell 130, which therefore provide at least some mutually-overlapping coverage at the location of the UE.

During normal operation of the telecommunications network 100, the UE 110 is connected to the first small cell 120-1 by means of a wireless connection 150-1, and in turn the first small cell 120-1 is connected to the core network 140 by means of a backhaul connection 150-2. The second small cell 120-2 and the macrocell 130 are also connected to the core network 140 by means of backhaul connections 150-3 and 150-4 respectively.

Backhaul connections 150-2, 150-3 and 150-4 are available to be wired or wireless Wide Area Network (WAN) connections and each connection is available, in part, to share common equipment. As may typically be the case, the backhaul connections for the first and the second small cells 150-2, 150-3 are less reliable than the backhaul connection for the macrocell 150-4 (e.g. owing to less resilient connection infrastructure and power supplies, and being less accessible for maintenance because of being located away from operator-accessible premises); as a result, backhaul connections 150-2, 150-3 may be more prone to failure.

Within FIG. 1a there is shown a prior art process for radio access point selection by UE 110 in the event that connection 150-2 between the first small cell 120-1 and the core network 140 fails. Connection 150-2 may fail for reasons including, but not limited to, a failure associated with a: WAN link; power outage; firmware download; network re-configuration; and signal synchronisation issue.

When connection 150-2 fails, conventional existing mechanisms cause the UE 110 to detach from the first small cell 120-1, for example by means of procedures as described in 3GPP Technical Specification 24.301, “Non-Access-Stratum (NAS) protocol for Evolved Packet System (EPS); Stage 3”, Version 16.5.1, the content of which, and in particular section 5.5.2.3, are hereby incorporated by reference.

In accordance with such conventional existing mechanisms for detachment, the first small cell 120-1 first deactivates its transceiver such that connection 150-1 is terminated. In response, the UE 110 will initiate a cell reselection mechanism so as to connect to another radio access point. In the example of FIG. 1a, the UE will connect to the macrocell 130 via wireless cellular connection 150-5 given the propensity for cell reselection rules to prioritise a connection to macrocells over small cells, such as the second small cell 120-2. Therefore, in this example, service is restored to the UE via macrocell 130.

In contrast, FIG. 1b shows the telecommunications network 100, and in particular the UE 110, being operated according to a process 200 shown and described with reference to FIG. 2.

Process 200 is initiated at step 210, in which the UE 110 connects to the first small cell 120-1 via connection 150-1, which is designated as a default small cell for the UE 110 according to a process shown in, and described below with reference to, FIG. 3.

Designation of a default small cell for the UE 110 means that, via appropriate cell selection rules, the UE 110 is instructed to connect to the default small cell (i.e. the first small cell 120-1), when such a default small cell is available, in preference over all other radio access points of the telecommunications network 100 (i.e. macrocell 130 and the second small cell 120-2). That is, the default small cell is a designation of the most-preferred radio access point (for the telecommunications network 100) for the UE 110.

As per the example of FIG. 1a, and by way of the same mechanism, when connection 150-2 fails, connection 150-1 is terminated. Accordingly, at step 220 an assessment is made by the UE as to whether connection 150-1 remains operational.

If it is determined at step 220 that connection 150-1 is operational, then steps 210 and 220 reiterate, thereby providing a process for ongoing assessment of the operation of connection 150-1.

If, however, it is determined at step 220 that connection 150-1 is not operational, then process 200 continues to step 230, in which an assessment is performed by the UE 110 as to whether an alternative default small cell has been designated for the UE 110.

The alternative default small cell is a small cell to which, according to appropriate cell selection rules, the UE 110 is instructed to connect when the alternative default small cell is available, but when the default small cell is not available, in preference over all other radio access points for the telecommunications network 100 (i.e. macrocell 130). In the example of FIG. 1b, the second small cell 120-2 is designated as the alternative default small cell according to a process shown in and described below with reference to FIG. 4.

If the UE 110 identifies that no alternative default small cell has been designated, then the UE performs conventional cell re-selection (as described in relation to FIG. 1a) 240. This would typically result in the UE establishing a connection 150-5 with the macrocell 130 (for the reason provided above), following interaction with the macrocell 130 and the second small cell 120-2 as part of a cell search and selection procedure.

If, however, the UE 110 identifies that an alternative default small cell has been designated at step 250, the UE directly attempts attachment with only the identified alternative default small cell. If, attachment fails, then the UE performs a conventional cell search and selection procedure as per step 240.

If, as per the example of FIG. 1b, attachment to the alternative default small cell is successful (i.e. via wireless connection 150-6), then the UE is connected to the alternative default small cell at step 260, thereby connecting the UE to the core network 140 (i.e. via connection 150-3) and allowing resumption of services to the UE. In this way, connection 150-6 is established without the UE 110 having entered into a cell search and selection procedure, which may involve extensive (sometimes, exhaustive) processing of available radio access points.

Whilst connected to the alternative default small cell at step 260, process 200 reiterates to step 220 such that the UE continues to monitor an availability to reconnect to the default small cell. In one example, the UE is configured to reconnect to the default small cell following reiteration from step 260 to 220 only once certain criteria have been satisfied, such as a connection to the default small cell having been available for at least a pre-determined duration.

It should be understood that regardless of whether an alternative default small cell has been designated or not (and therefore whether the UE proceeds to step 250 or 240 respectively), the UE may in either case still attempt attachment to the second small cell 120-2. However, the processing that is undertaken by the UE to attach to the second small cell 120-2 is different in each case, with the UE performing a search and selection procedure in step 240 when no alternative default small cell is provided, thereby expending greater processing resources and power, as well as generating greater radio overhead signalling, compared to the processing of step 250.

FIG. 3 shows a process 300 for identifying and designating a default small cell for the UE 110, as performed by the UE.

In a first step 310, a determination is made as to whether a small cell has already been identified as a default small cell for the UE 110. If so, process 300 proceeds directly to step 350 so as to designate the identified small cell as the default small cell. If not, however, process 300 proceeds to step 320 so as to identify a suitable default small cell automatically.

As described above, a default small cell for a given UE is characterised by the UE prioritising a connection to that default small cell over other radio access points. As such, it is desirable that the default small cell is frequently available to the UE and provides suitable network performance.

At step 320, the UE determines whether at least one small cell is available; if so, the process proceeds to step 330 having recorded at step 320 the identities of each available small cell, and if not, then step 320 reiterates after a pre-determined delay.

At step 330, the UE 110 determines characteristics for each available small cell; these characteristics are available to include a/an:
proximity of a small cell relative to a pre-defined location, in which, for example, the pre-defined location is available to be a most-frequently visited location or a home residence or a place of work as designated by a user associated with the UE;
total duration of historical connections between the UE and a small cell;
frequency of connections and/or disconnection between the UE and a small cell;
recentness of a connection between the UE and a small cell;
signal strength between the UE and a small cell;
PLMN ID of a small cell;
availability of a pre-defined functionality by a small cell;
distance between the UE and a small cell; and/or
firmware and/or hardware version of a small cell.

At step 330, the UE also compares the compiled characteristics for each small cell against a set of pre-determined criteria for the characteristics, including threshold values, as described in more detail below.

If a given small cell fails to meet pre-determined criteria for a characteristic, then that small cell is disregarded from further processing for identifying a default small cell, and therefore cannot be designated as a default small cell.

At a next step 340, a ranking of each remaining available small cell (i.e. that has not been disregarded at step 330) is generated based on an aggregate of the compiled characteristics (including a weighting thereof).

The small cell that is ranked highest following the processing of step 340 is therefore identified at step 340 as the default small cell on the basis that it is a small cell which is optimally available to the UE and provides a sufficiently-reliable connection, as is desirable of a default small cell.

In a final step 350, the identified small cell (following the output of steps 310 or 340) is designated within memory of the UE (and in particular within a Subscriber Identity Module (SIM) card) as the default small cell for that UE.

Although not shown in FIG. 3, it will be appreciated that step 340 is available to be bypassed, thereby to proceed to step 350, if only a single small cell is identified in step 330 as not to be disregarded.

FIG. 4 shows a corresponding process 400 for identifying and designating an alternative default small cell for the UE 110, as performed by the UE.

In a first step 410, the UE 110 identifies whether the UE is presently connected to its designated default small cell (having been designated according to process 300). If not, step 410 re-iterates after a pre-determined delay or until process 400 is triggered following connection to the default small cell.

If the UE is presently connected to its designated default small cell, then process 400 continues to step 420, during which the UE identifies at least one alternative small cell (i.e. other than the default small cell) that is available to the UE. By being connected to the default small cell during processing of step 420, this ensures that any alternative small cell (and therefore the alternative default small cell that is eventually selected) can be expected to be available when the UE is connected to the default small cell, and therefore likely to be a reliable failover for the default small cell.

Next, at step 430, in a corresponding way to that of step 330 in process 300, characteristics are determined for each alternative small cell by the UE; these characteristics are available to include a/an:
proximity of the UE to an alternative small cell;
total duration of historical connections between the UE and an alternative small cell;
frequency of connections and/or disconnection between the UE and an alternative small cell;
recentness of a connection between the UE and an alternative small cell;
signal strength between the UE and an alternative small cell;
PLMN ID of an alternative small cell;
availability of a pre-defined functionality by an alternative small cell;
distance between the UE and an alternative small cell; and/or
firmware and/or hardware version of an alternative small cell.

Also at step 430, and again in a corresponding manner to step 330, the determined characteristics for each alternative small cell are compared to pre-defined criteria for the characteristics. If a given alternative small cell fails to meet pre-determined criteria, then that alternative small cell is disregarded from further processing for identifying an alternative default small cell, and therefore cannot be designated as an alternative default small cell.

With reference to both steps 330 and 430, the pre-defined criteria are available to include that a small cell (i.e. for candidacy as a default small cell) and/or an alternative small cell (i.e. for candidacy as an alternative default small cell):
is located at (or within a certain proximity of) the pre-determined location (this is because a UE is typically best served by a small cell that is associated with that UE due to network performance ring-fencing, such as by being located within a premise (i.e. a pre-defined location) of a user of the UE and/or forming part of a hybrid access point that also provides a private (i.e. encrypted) fixed-line broadband service for the UE);
has established a connection with the UE for at least a certain total period of time, at least a certain number of times, and/or within at least a certain period of time; and/or
meets a threshold value for network performance, such that at least a given average availability, latency, bandwidth, and/or signal strength is met;
supports a certain specific network functionality, such as VoWiFi or operability within a certain radio-frequency band, such as mmWaves;
is within a given distance of the UE; and/or
has a PLMN ID that is associated with a telecommunications network to which the UE 110 is a subscriber (or is at least available to access, for example via roaming).

In one example, the pre-defined criteria are pre-defined by an operator of the telecommunications network 100, which are then subsequently communicated to the UE.

In one example, the pre-defined criteria are, where available, equivalent in steps 330 and 430, and in another example the pre-defined criteria are set to be less selective at step 430 than at step 330.

At a next step 440, each remaining candidate alternative default small cell is ranked based on an aggregate of the compiled characteristics (including a weighting thereof).

Finally, at step 450, the candidate alternative default small cell that is identified as having the highest ranking is designated within memory of the UE (and in particular within a Subscriber Identity Module (SIM) card) as the alternative default small cell for that UE.

If the default small cell for a given UE should change (in a further iteration of process 300), then process 400 also reiterates since the alternative default small cell may also change.

Alternatives and Modifications

Whilst the aforementioned has exemplarily been described in relation to small cells, it will be appreciated that the default small cell and/or the alternative default small cell are alternatively available to be any form of radio access points for cellular telecommunications networks, and the process may still yield the same benefit of faster and more efficient radio access point reselection for UEs, as well as reduced end user connectivity and service interruptions, albeit that the benefit is likely most pronounced in application to small cells.

In one example, a plurality of alternative default small cells are identified, and step 260 is performed so as sequentially to attempt connection to each of said plurality of alternative default small cells in descending order based on the rankings as identified at step 440 until a connection is established with any alternative default small cell. However, the plurality of alternative default small cells that are identified comprises no more than the number of small cells for which an attempt to access every alternative default small cell would require longer than an expected time to perform a conventional cell search and selection procedure. As such, the plurality of alternative default small cells typically comprises between two and six small cells.

In one example, the aforementioned processes are suitable for implementation in so-called neutral-host networks (in which a third party deploys radio access point for use by a network operator as part of their network). As such, the first and second small cells 120-1 and 120-2 are operated by the same neutral-host network, which is different to the operator of macrocell 130. Since a neutral-host network business model is incentivised to seek to handle traffic over neutral-host network radio access points, the aforementioned process may help move or retain UEs on a neutral-host network (i.e. where the alternative default small cell forms part of the neutral-host network) in an efficient manner.

In one example, processes 300 and 400 are performed over a relatively long period of time (such as approximately a week, or longer) in order to ensure that the default small cell and the alternative default small cell are selected so as accurately to reflect typically-available small cells for the UE. In particular, the characteristics that are obtained in steps 340 and 430 are available to be measured on several instances over this period of time, such that the default small cell and the alternative default small cell are selected based on time-averaged values of the characteristics.

In one example, steps 330 and 430 are performed so as to determine the characteristics of small cells in a prioritised manner, for example based on a highest signal strength first.

In one example, the default and alternative default small cells are static (and not moving) small cells.

In one example, the default small cell and/or the alternative default small cell may be manually designated by a user of the UE, albeit that the alternative default small cell is required to be available to the UE when the default small cell is also available.

Each feature disclosed herein, and (where appropriate) as part of the claims and drawings may be provided independently or in any appropriate combination.

Any reference numerals appearing in the claims are for illustration only and shall not limit the scope of the claims.

1. A method of operating User Equipment, UE, the UE being configured to connect to a wireless wide-area cellular telecommunications network, said telecommunications network comprising a plurality of radio access points, and the method comprising the steps of:
identifying, from the plurality of radio access points, a default radio access point for the UE;
identifying, from the plurality of radio access points, an alternative default radio access point for the UE, wherein said identifying is performed based on the alternative default radio access point and the default radio access point having been simultaneously available to the UE for wireless connection and wherein the UE is instructed to connect to the default radio access point in preference to the alternative default radio access point;
connecting the UE to the default radio access point; and
in response to the UE detecting a subsequent loss of connection with the default radio access point, the UE directly initiating only a connection with the identified alternative default radio access point.

2. A method according to claim 1, wherein initiation of the connection to the alternative default radio access point is performed without the UE attempting attachment to a radio access point other than the alternative default radio access point.

3. A method according to claim 1, wherein directly initiating only a connection with the alternative default radio access point is performed despite at least another radio access point of the being available to the UE for wireless connection.

4. A method according to claim 1, wherein the identity/identities of the default and/or the alternative default radio access point/s is/are stored within memory of the UE.

5. A method according to claim 1, wherein the default radio access point is a small cell.

6. A method according to claim 1, wherein the alternative default radio access point is a small cell.

7. A method according to claim 1, wherein identifying the default radio access point comprises identifying a radio access point that is available to the UE at a pre-defined geographic location.

8. A method according to claim 1, wherein identifying the default radio access point and/or the alternative default radio access point is performed in dependence upon a total duration of connections with the UE.

9. A method according to claim 1, wherein identifying the default radio access point and/or the alternative default radio access point is performed in dependence upon a total number of instances of connections with the UE.

10. A method according to claim 1, wherein identifying the default radio access point and/or the alternative default radio access point is performed in dependence on a level of network performance.

11. A method according to claim 10, wherein the level of network performance comprises an average of a plurality of measurements for network performance over a period of time.

12. A method according to claim 1, wherein identifying the default radio access point and/or the alternative default radio access point comprises identifying a radio access point providing a pre-defined network function.

13. A method according to claim 1, wherein identifying the default radio access point and/or the alternative default radio access point comprises identifying a radio access point having a network identifier that is associated with a telecommunications network that the UE is available to access.

14. A method according to claim 1, wherein identifying the alternative default radio access point is only performed after the default radio access point has been identified.

15. A method according to claim 1, further comprising the step of, in response to identifying a failure directly to initiate a connection with the alternative default radio access point, the UE performing a radio access point search and selection process for a radio access point other than the default radio access point and the alternative default radio access point.

16. A wireless wide-area cellular telecommunications network comprising:
a plurality of radio access points;
a UE for connecting to the telecommunications network via the plurality of radio access points, wherein said UE is configured to perform a method according to claim 1.

17. A computer-readable carrier medium comprising instructions which, when executed by a computer, cause the computer to carry out a method according to claim 1.
